(19) United States
(12) Patent Application Publication
(10) Pub. No.: US 2013/0343353 A1
(43) Pub. Date: Dec. 26, 2013

(54) Internet Of Things long range many units communication networks

(71) Applicant: Benjamin Maytal, Mevasseret-Ziom (IL)

(72) Inventor: Benjamin Maytal, Mevasseret-Ziom (IL)

(21) Appl. No.: 13/922,272

(22) Filed: Jun. 20, 2013

Related U.S. Application Data
(60) Provisional application No. 61/661,823, filed on Jun. 20, 2012.

(51) Int. Cl. H04W 84/04

(52) U.S. Cl. CPC H04W 84/04
USPC 370/336; 370/328; 370/329

(57) ABSTRACT

The concept of “Internet of Things” is about allowing things and object to connect together over the internet It is expected that a major portion of the “things” to be connected will be a mass number of sensors or controllers, for applications like “Smart City”. It is expected that each sensor will send a brief messages every few minutes.

The existing communication solutions do not allow more than few thousands of active units and a relatively high power consumption, usually over short distance.

The present invention will describe a method and system which will allow a very large number, potentially tens of millions to communicate with a single base station center over a long distance. The communication will be ultra low power with no battery replacement and will allow real time control messages.

### CROSS-REFERENCE TO RELATED APPLICATIONS

This non provisional patent application claims benefit of the filing date of provisional Application 61/661,823 filed on Jun. 20, 2012 as a priority date for this application.

### BACKGROUND

“internet of things” is about connecting to the internet things—not people. There can be several types of “things”—for examples, machine to machine communication, which can be handled effectively over the mobile network

It is expected that a major portion of “things” will be in a “Smart City” solution. Smart city is about allowing optimal control of the city infrastructure—electricity, water, gas, fuel, sewage for best resource utilization and inhabitants quality of life. This will require a very large number of sensors, and controllers connected to the city management server over the internet. Such a system is also called “sea of sensors”—the number of such units in a big city can be 10s of millions, as there can be several such units per house.

It is expected that each sensor will deliver a short (e.g. 1 byte) message every several minutes (e.g. 15 minutes).

For example a water meter can report it's reading every 15 minutes, This will not only save the water company money for eliminating manual reading, but will allow it to control the system. For example, a pipe explosion to a house garden can be detected and the water to the house can be automatically shut down and an SMS sent to the owner.

There are no existing communication solutions for this market

White Space Spectrum is the name given to the VHF, UHF frequencies (50-850 MHz) used for analog TV. They were allowed recently for free use in the USA and the UK. The clear advantage of these frequencies is their penetration through walls and other obstacles due to the low frequencies used—a 3G mobile network is using 2.1 GhHz and Wi-Fi 2.4 GHz, where the depth of penetration is inversely proportional to the frequencies used.

### PRIOR ART

There is a range of communication solutions—but they are all not serve the “Smart City” application well.

Mobile networks (2G, 3G, 4G) have a small number of units actively connected to them (in 3G for example) because of the number of codes is limited)—the connection time is few seconds—when the message itself is few microseconds, There is also a very large overhead ob the message. The results will ne a limited number of units with very high power consumption.

Local networks (Wi-Fi, Zigbee, PLC) are all focused on a local, small area coverage, This means that many gateways needs to be scattered in a city.

There are new long range, low bandwidth standards—Sigfox and Weightless.

They can both support only several thousands of units.

Sigfox has very limited bandwidth (<1 kbps) and Weightless has a long frame and long time out of sleep.

### SUMMARY

The present invention will describe a system and methods which can connect up to 100M units to the network with a single base station. Every unit will be capable of delivering a short message every few minutes,

The system will use TDM—Time Division Multiplexing where each units will send a message in it's time slot. The messages will be only to the center, messages from the center can be supported as well.

Synchronization of the units will be achieved not by using digital messages, but by sending a signal from the base station. A special type of a signal, called “Signaling Messagel or “Signaling Message” will be used as will be explained in detail.

Each units will be identified by its timing—messages will be sent with no overhead. “Signal Signatures” can be used for bi-directional real time messages.

For best performance, White Space spectrum frequencies will be used, with a channel allocation. It will be explained how a single channel cans support multiple applications.

### BRIEF DESCRIPTION OF THE DRAWINGS

FIG. 1 is a system description of a communication device

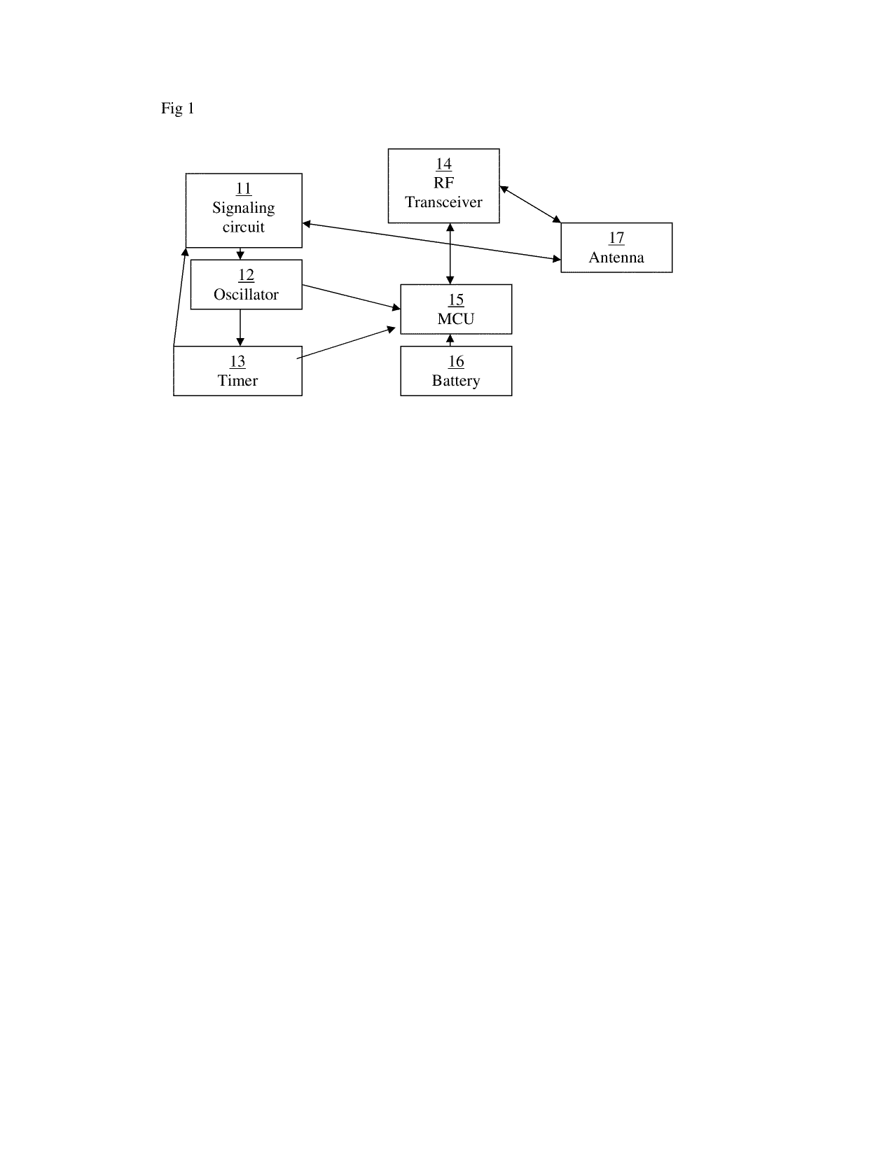

FIG. 2 is a frequency diagram of a Signaling Message

FIG. 3 is a timing diagram of the clocks in the base station and a device

FIG. 4a, 4b are system description of method of Signaling Message recognition for synchronization.

FIG. 5 is a system description of one method of Signaling Message recognition

FIG. 6 is a description of a system with multiple application base stations.

### DETAILED DESCRIPTION

The present invention will implement a long range wireless network, using RF signals, which will be able to connect a very large number (up to 100M units) to a single base station. The following disclosure will describe a base station and communication devices implementing the invention.

For best performance utilization of the White Space Spectrum is proposed, however, the invention can work at any frequency range.

Three frequency ranges will be used in the system, they can be separate or continuous, if White Space Spectrum is used a single 6 (or 8 in Europe) MHz channel will be used, for example 56-62 MHz.

There will be a message frequency range (e.g. 5 Mhz), signaling frequency range (e.g. 900 Mhz) and set up frequency range (e.g. 100 MHz).

The messages will be sent over the message frequency range.

It is expected that a standard modem, using standard modulation technologies will be used and that a data rate of at least 1 mbps will be achieved. The modulated signal will be carried over a carrier in the range (e.g. 100 MHz).

It is expected that the central base station will use high power (e.g. 4 W under the White Space Spectrum standard) and that each unit will use a low power (e.g. 100 mw power), this will allow communication over a range of few kilometers.

The invention relates to communication devices in the network. Each such device will be connected to a sensor, a meter or a controller to provide service.

Each communication device per this invention will be built as described in Fig . . .

An antenna 17 will be connected to RF transceiver 14 and to signal circuit 11. The RF transceiver will be connected to an MCU 15, which will execute the modulation and message preparation and control, The signal circuit will be connected to an Oscillator 12 and to a timer 13, which will also be connected to the oscillator, which will also drive the MCU 15. A battery 16 will provide power. It can be connected to a solar cell.

It is expected that TDM will be used for network sharing, and that every unit will get it's time slot—the timing after a start of a global message frame and the size.

When a new unit will be plugged into the network it will send a Signaling Message over the Signaling frequency range with it's ID (to be later described) to the base station. The base station, based on the ID and it's data base will know what type of a unit it is. It will respond by sending back the same Signaling Message with set up information over the set up frequency range—start timing, number of bits to be sent, number of bits to be received). For example 145,678.901, 8, 4 which will indicate to the unit it needs to start sending it's message 145,678.901 after the start of global frame. It can ask for location information the units can have if it has a GPS inside it. All the signals will be sent over the signal frequency range.

There will be a global frame time—the time it takes for all units to send and receive their messages. This time frame can change is units can be added or deleted from the system.

The base station will sent a start of frame Signaling Message on the start of every new frame so the timing for every unit will be counted from this point.

If a 1 mbps modem is used and the message is a byte than every unit will send a message for 8 usec. It can than wait for a message to be received from the center. A safety gap (e.g. 2 usec) will ne put between messages—but no other overhead, there will be no header.

Each unit can have an IP address but the translation between IP addresses and message timing will be done at the central base station.

Since the units will be several km away from the base station (e.g. 5 km) a measurement of the delay time is required.

The base station will send every hour a delay measurement message to the unit, which will send a signal back, and the base station will send a signal back—both base station and the device will be able to know what is the delay time.

As explained, the “Signaling Message” is the base for the functionality of the invention.

In standard communication system digital messages are exchanged between a unit and the base station or gateway. This mechanism takes a ling time and requires the unit to listen constantly, or at least for a long period of time.

The proposed mechanism of “Signaling Message” or “Signal Signature” is about exchanging analog signals and detecting them using passive or semi-passive circuitry without needing to wait.

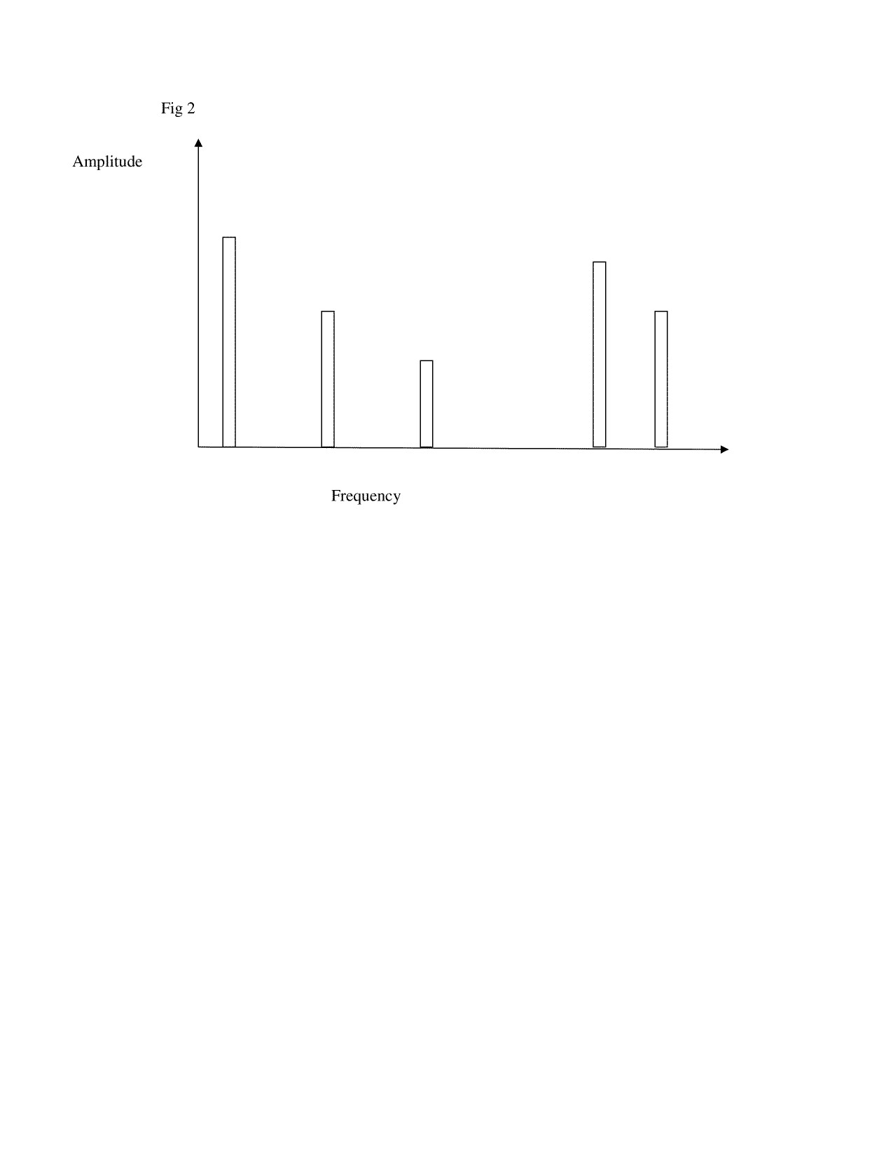

It is described in FIG. 2. In the signal frequency range, each “signature” or “signaling message” will have a group several signals at different frequencies selected from a group of allowed signals, for example, it can have 5 such signals. Each such signal will have it's range (e.g. 5 Khz) and will be separated from another signal with a gap (e.g. 1 Khz). This means that for example in a 900 Mhz range there can be 150 such signals. For example 10 KHz, 1000 KHz, 200 KHz, 230 KHz, 410 KHz, 720 KHz, The signals will be sent over the carrier (e.g. 100 Mhz) using frequency modulation.

Each such signal will have it's own amplitude. For example, there can be 8 potential values. Under this example, there will be a total of 1200 potential signals. Each potential signature or signaling message will have multiple such signals. If for example 5 are used, this means that there can be 1200 by the power of 5 such messages—more than 10 by the power of 15. Every signal in this example is like 3 decimal figures—so short messages can be constructed using instead of digital bits analog signals.

Such signaling can be used between the base station and each device over the signal frequency range. It can be used for synchronization, device ID or other messages. Since it is expected that the environment will be very noisy, redundancy can be used—e.g. if only 3 out of the 5 signals are received well the message will be understood. In our example this means more than a billion messages, or IDs.

The fact that a certain signal at a certain frequency is well received is determined by examining it's amplitude—is it stable over a certain period of time and is it at the right ration with the other signals.

The Signaling Message will be sent in the signal frequency range, over the carrier signal, e.g. 100 Mhz, effectively signals at e.g. 100.01, 100.1. 100.2, 100.23,100.41, 100.72)

The first purpose of the Signaling Messages is for synchronization, which is a must for a TDM operation. The unit and the base station need to be synchronized within 1 usec.

It is expected that there is a 20 ppm drift in each of the oscillators, which means a 28 ppm time drift between a device and a base station. This means a drift of about 30 msec every second,

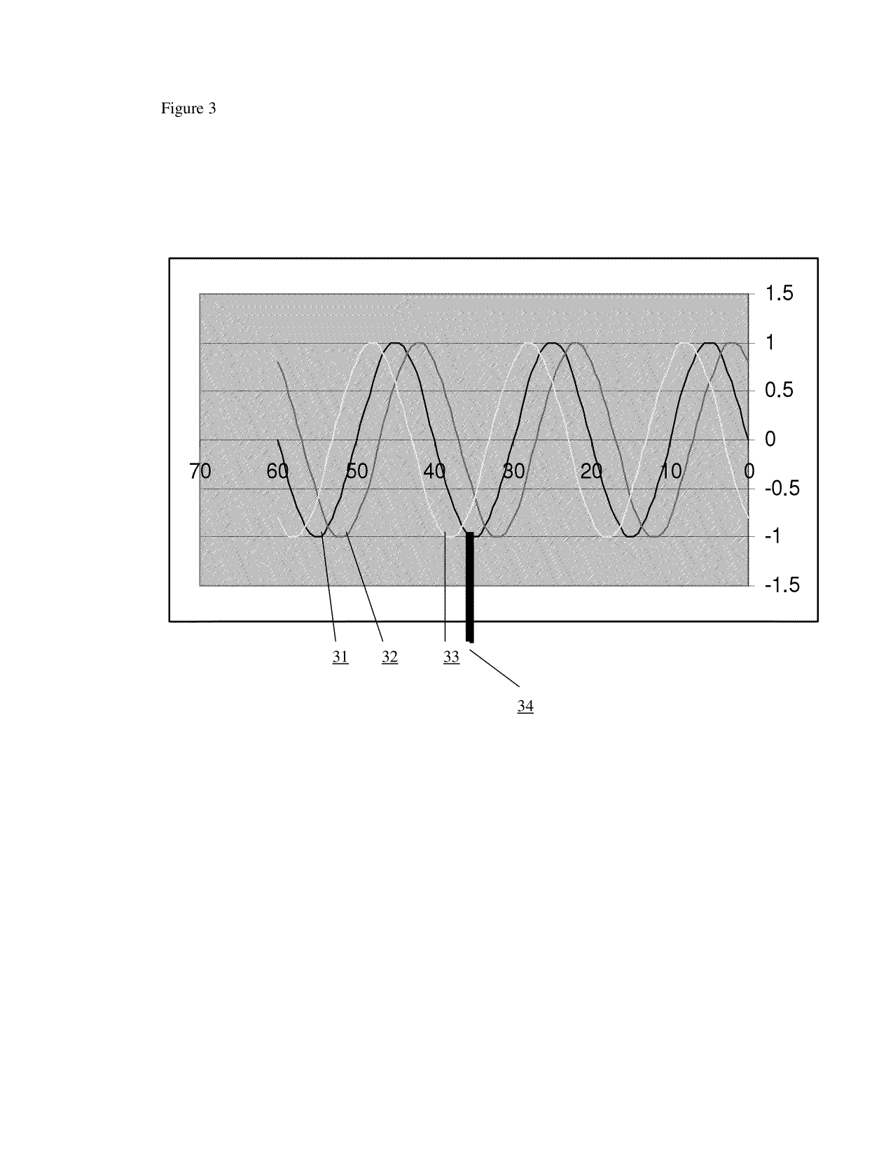

An example of such a time drift is show in FIG. 3—where a time drift after several ms is shown. The base station signal 31 is shown. There can be a drift after—signal 32 or before, signal 33—since this will be a short time frame they are still in the same cycle range, and not completely out of sync.

This invention will describe how signaling messages can be used for synchronization.

The methods used today for synchronization are message methods—the most know is the 1588 standard, They require the device to listen and for three messages to be sent. This takes a considerable amount of time. In Zigbee, for example, wake up time from sleep is 30 ms.

Three methods will be used, they are all based on the “Signaling Message” method described above.

A special signaling message will be sent from the base station. Because of it's importance and high degree of redundancy can be used and it can be repeated several times.

It is desired to use passive circuitry to detect the signature. A carrier cancelation operation is required to allow passive signaling message recognition. A passive circuitry can tell between a 10 KHz signal and a 20 Khz signal but not between a 100.01 MHz and 100.02 MHz.

Three methods for detecting the synchronization signal with minimal power consumption are described.

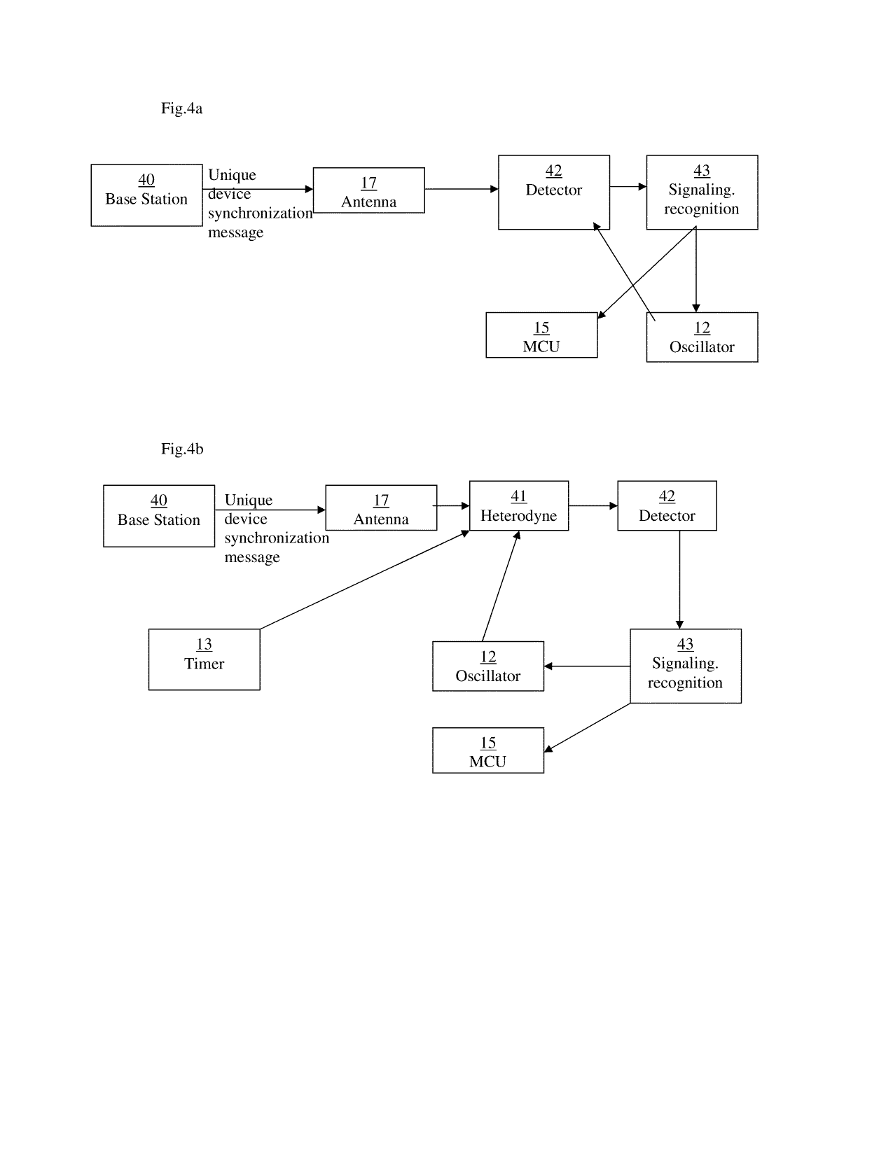

Under the first, there is an acceptance of a good and strong signal (repetition is allowed). It is described in FIG. 4a

The base station 40 will send a synchronization signaling message with a unique device ID. It will send it per device at the right timing per device, taking into account the delay time. The message will be transmitted from the antenna 17 to a passive detector circuitry 42 (inductor, capacitors, resistors). It will send the signal after carrier cancelation to signaling recognition circuitry 43. This circuitry is designed to recognize specific frequencies using passive components (resistors, capacitors, inductors) and will be different for each communication device. It will be used in the other 2 methods as well It is possible to have programmable/changeable components. This circuitry will be able to detect the signal frequencies and received and their amplitude ratio and will be able toe decide if it received the proper message or ID. Each such circuitry can have a positive result only for one specific message without any power consumption.

Once it has recognized that the proper ID has been received it will activate the MCU 15 and Oscillator 12. It will send an acknowledgment message with the device ID in a “Signaling Message” to the base station. 40

This passive circuitry in 43 and 51 will work all the time—but without any power consumption!, all other synchronization messages intended for other devices will pass through them—but they will not be recognized.

If, however, the received signal is constantly not strong or clear enough, a passive circuitry cannot be used for carrier cancelation circuitry will require an active heterodyne and a detector.

One such method is described in FIG. 4a,

Here, to significantly reduce the power consumption a timer 13 will be used, It will detect when the units is getting, with the oscillator inaccuracies, to a range where a synchronization message is possible, If a message is sent every 15 m this will mean 25 ms before the timing of the device. It will activate the heterodyne 41. The heterodyne will be active and power consuming during this time only. The heterodyne will use the clock signal from Oscillator 13 and together with detector 42 will perform the carrier cancelation. The rest of the process is as described above for FIG. 4a.

Under both 4a and 4b the unit broadcast time is controlled by the bade station—it will start transmission when a proper signaling message is received, but the device is out of sync with the base station.

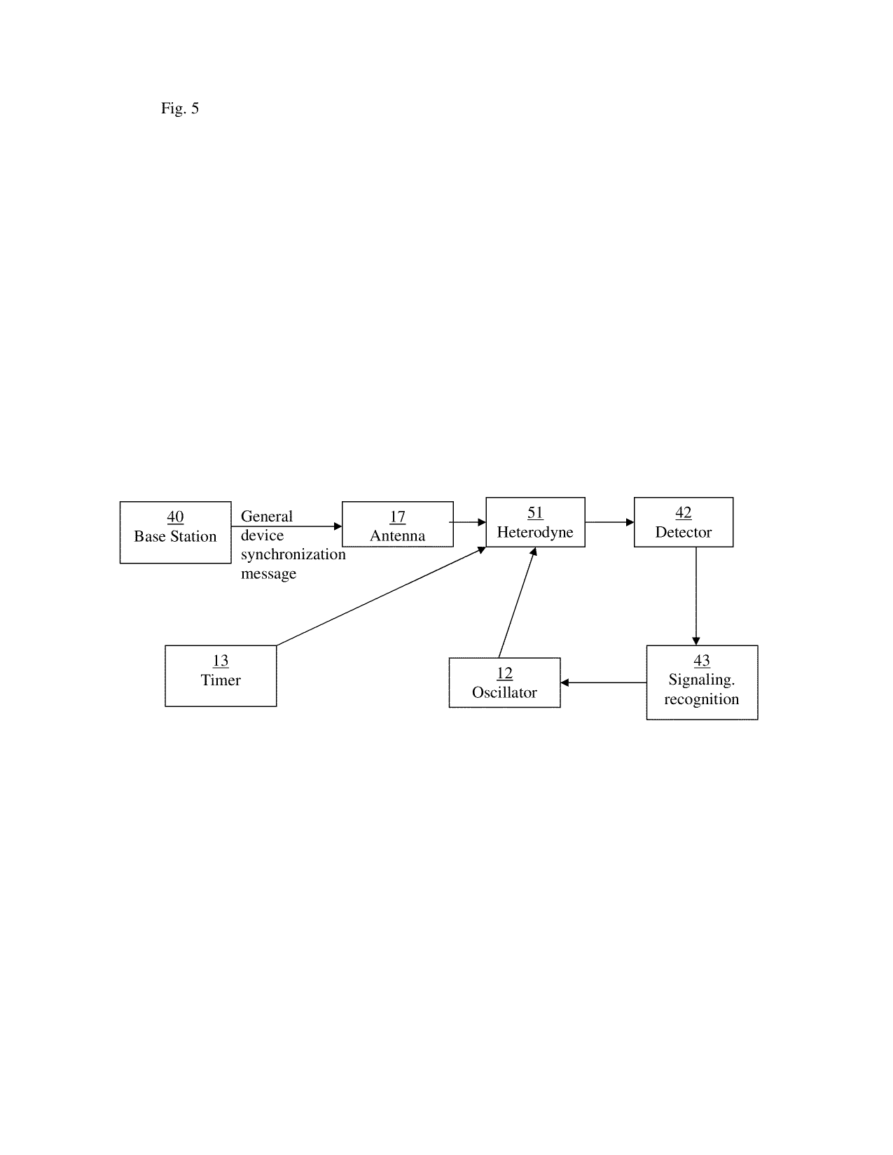

An alternative method is described in FIG. 5.

The circuitry here is the same as in FIG. 4b, just that the base station 40 is issuing a generic synchronization message to all units every short period of time—e.g. 5 ms, where the time drift is small (no more than 1 usec). The timing between the units and the base station will be as seen in FIG. 3.

Time 13 will issue an activation signal to the heterodyne 41 when such a signal can arrive, taking into account the known synchronization period and the potential drift. If for example the period is 5 ms the potential drift if about 0.1 us, so there will be a window of +−0.1 usec of activation.

The rest of the recognition process will be the same as described above.

However, under this embodiment, the MCU will be awakened by it's timer and will start sending a message independently at the right time. The base station will know based on the timing where this message is coming from.

For a Smart City communication system it is very important to send bi-directional real time messages, which will allow real time operation. For example, if a temperature sensor in a house detects that the temperature is above threshold (e.g. 50 c) the power to the house will be immediately shut down.

Signaling Messages will be used in both directions.

Potentially there can be a separate frequency range for synchronization and for messaging.

The device will issue a Signaling Message with it's unique ID. Potentially there wei

The base station will recognize it, and will know what the message means—if this is this temperature sensor this means a temperature above 50 c in the house. It can observe the situation in other houses. It can send a control message to shot down the electricity.

The controllers will have a separate frequency range for control messages, as they will not be using the data message range.

A controller can identify a message based on the method described in 5a.

If this is not possible, a system like described in FIG. 4 can be used, but there will be specific messages sent. The controller active heterodyne will be activated every time a control message is being sent, but since this is a rare event, it will not cause power issue.

Under a first option, every controller can receive only one type of a message—for a controller controlling the home power this is a toggle between on/of. Only a device ID will be sent and the device will respond accordingly.

To allow several types of messages and to overcome cyber attack by changing the Signaling Message, first a device ID will be sent and then a second signaling signature with the message type or new message code will be sent.

When using White Space Spectrum frequencies, a TV channel (6 MHz US, 8 MHz Europe) is being assigned for this service.

It is possible to have one service provider which will cater for all applications, but it is desirable to allow a certain application (e.g. water meters in a city) to be provided using its own base station. This application can have different requirements from other applications.

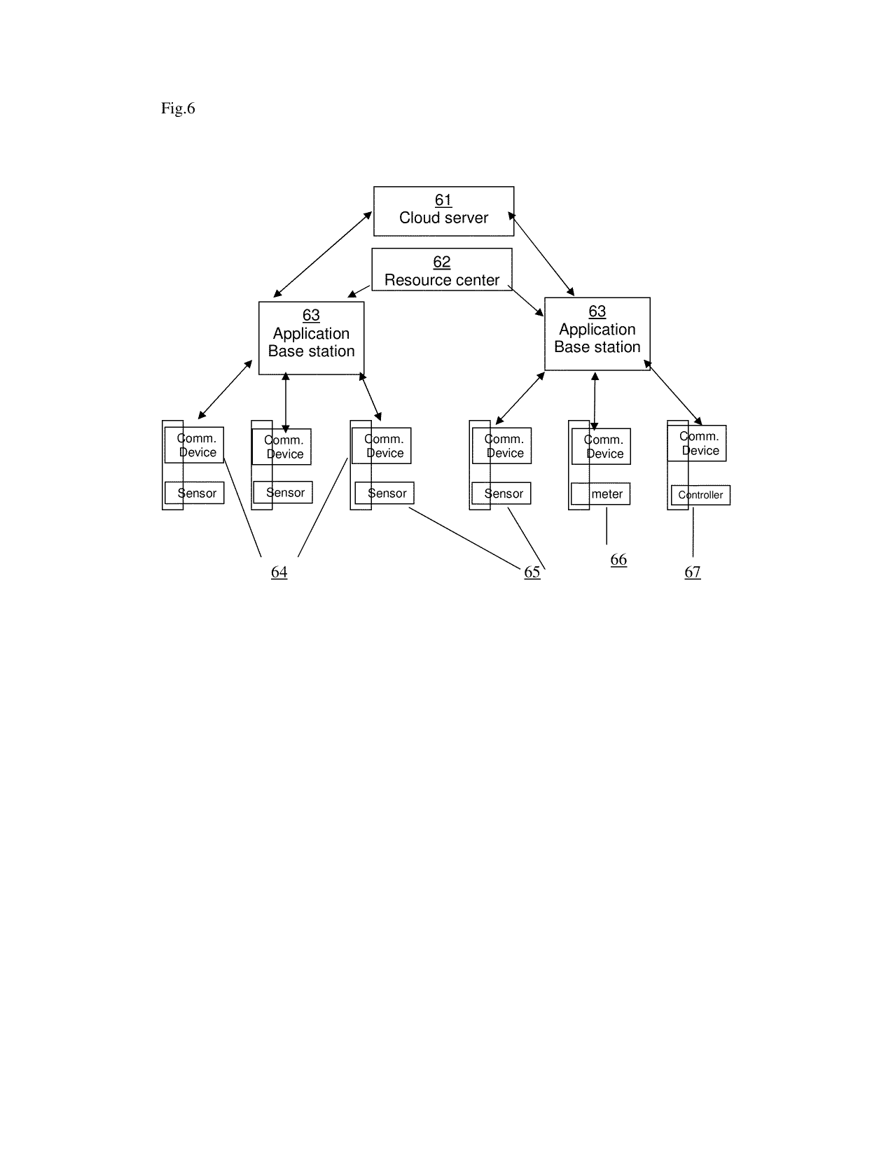

FIG. 6 describes a system allowing multiple application to use the same allocated channel.

Each application based station 63 is connected to multiple communication devices 64, implementing the present invention. Each communication device is connected to a sensor 65 or controller 66.

A resource manager 62 is allocating resources to the base stations. These can be frequencies or time share. To allow maximum flexibility, a base station can for example allocate the time share out of a minute—it can give a certain share (e.g. 30%) to a certain base station.

It is expected that the bases station are only handling the communication, and the application and it's interface will be handled by cloud server 61.

What is claimed is:

1. A system comprising an antenna, an RF transceiver, an MCU, and signaling circuitry,

2. A method for sending messages from a base station to a communication device or from a communication device to a base station, using a Signaling Message, which will be built using a group of RF signals, each signal at a different frequency and potentially a different amplitude, where each signal frequency and amplitude is selected from a group of allowed frequencies and amplitudes.

3. A method as in claim 2, where a certain message can be understood by the receiving party if only a portion of the signals in the group is of good quality.

4. A method as in claim 3 where the signal quality is determined if it maintained the planned amplitude ratio to the other signals.

5. A method as in claim 2, where the Signaling Message can be recognized by doing carrier cancellation operation and then going to a passive frequency and amplitude recognition unit.

6. A method as in claim 5 where the carrier cancelation is done by a passive detector

7. A method as in claim 5 where the carrier cancelation is done by a heterodyne and a passive detector

8. A method as in claim 7 wherein the period of time the heterodyne is active will be limited for power saving purposes for the required time.

9. A method as in claim 2, where the signaling message is being used for synchronizing a device to a base station.

10. A method as in claim 5 where the synchronization is achieved by the base station sending a Signaling Message for a particular device at the right timing for this device to start operation.

11. A method as in claim 10, where the device will start broadcasting after it has received such a message.

12. A method as in claim 9 where the base station is sending at periods short enough to enable the devices to remain within a short timing range from the base station, the message indicating to the device oscillator to start it's clock at this timing.

13. A method as in claim 12 where the device will start broadcasting independently at the right timing.

14. A method as in claim 2 where a device can send a Signaling Message indicating a predetermined event has occurred to the base station

15. A method as in 8 where the Signaling Message will be the device ID.

16. A method as in claim 2 where the base station can send a control message to a device using a Signaling Message.

17. A method as in claim 10, where the Signaling Message will be the device ID.

18. A method as in claim 2, where the Signaling Message will instruct the device to do a single, predetermined action

19. A method as in claim 18 where the base station can send a changing control message to a device by following the sent ID message with a different message

20. A method as in claim 16 where the message will be the device ID.

21. A method as in claim 2, where a communication device is sending a signaling message with it's ID to the base station, indicating a predetermined event has occurred,

22. A system where multiple base stations can each be connected to communication devices connected to sensors, meters or comptrollers where a central resource manager will be allocating channel resources to each base station.

23. A system according to 18 where thee central resource manager will allocate frequencies out of the channel frequency range

24. A system according to claim 18 where the central resource manager will allocate a time share per base station.
